(19) United States
(12) Patent Application Publication
(10) Pub. No.: US 2021/0136728 A1
(43) Pub. Date: May 6, 2021

(54) BASE STATION, USER EQUIPMENT, SIGNAL TRANSMISSION METHOD, AND SIGNAL RECEPTION METHOD

(71) Applicant: NTT DOCOMO, INC., Tokyo (JP)

(72) Inventors: Shimpei Yasukawa, Tokyo (JP); Hiroki Harada, Tokyo (JP); Satoshi Nagata, Tokyo (JP); Liu Liu, Beijing (CN); Qun Zhao, Beijing (CN); Huiling Jiang, Beijing (CN)

(73) Assignee: NTT DOCOMO, INC., Tokyo (JP)

(21) Appl. No.: 16/074,176

(22) PCT Filed: Jan. 30, 2017
(86) PCT No.: PCT/JP2017/003122

§ 371 Date: Jul. 31, 2018

(30) Foreign Application Priority Data
Feb. 4, 2016 (JP) 2016-020325

(51) Int. Cl. H04W 72/00; H04J 1/08; H04W 72/12; H04L 5/00; H04W 72/04

(52) U.S. Cl. CPC H04W 72/005; H04J 1/08; H04W 72/1273; H04L 5/0032; H04W 72/1289; H04W 72/042; H04L 5/005

(57) ABSTRACT

There is provided a base station of a radio communication system including a plurality of base stations communicating with the user equipment, the base station including a generator configured to generate a downlink physical shared channel receivable by a plurality of units of user equipment based on a predetermined ID commonly configured in the plurality of base stations; and a transmitter configured to transmit the generated downlink physical shared channel to the units of user equipment with a predetermined subframe.

### TECHNICAL FIELD

The present invention relates to a base station, user equipment, a signal transmission method, and a signal reception method.

### BACKGROUND ART

In long term evolution (LTE) or LTE subsequent system (for example, referred to as LTE-advanced (LTE-A), 4G, or future radio access (FRA)), multimedia broadcast and multicast service (MBMS) for achieving broadcast delivery is defined. By using MBMS, it is possible to simultaneously transmit information to all the units of user equipment in a certain area by a common bearer. In addition, the units of user equipment supporting MBMS can receive information irrespective of an RRC connection state (RRC CONNECTED or RRC IDLE).

In MBMS, a transmission scheme using multi cells (a plurality of cells) referred to as multimedia broadcast multicast service single frequency network (MBSFN) is supported. The MBSFN is a transmission scheme in which user equipment can perform radio frequency (RF) combination of signals transmitted from base stations when the plurality of base stations forming MBSFN cooperate to simultaneously transmit the same signals together on the same frequency (see Non-Patent Document 1).

### PRIOR ART DOCUMENT

### Non-Patent Document

Non-Patent Document 1: 3GPP TS 36. 300 V13.2.0 (2015-12)
Non-Patent Document 2: 3GPP TS 36.331 V13.0.0 (2015-12)

### SUMMARY OF THE INVENTION

### Problem to be Solved by the Invention

There is a need for a technology that allows a plurality of base stations to cooperate to transmit information while efficiently using radio resources.

### Means for Solving Problem

According to an aspect of the present invention, there is provided a base station of a radio communication system including a plurality of base stations communicating with units of user equipment, the base station including a generator configured to generate a downlink physical shared channel receivable by the plurality of units of user equipment based on a predetermined ID commonly configured for the plurality of base stations; and a transmitter configured to transmit the generated downlink physical shared channel to the units of user equipment with a predetermined subframe.

### Effect of the Invention

According to the disclosed technology, there is provided a technique that allows a plurality of base stations cooperate to transmit information, while efficiently using radio resources.

### BRIEF DESCRIPTION OF DRAWINGS

FIG. 1 is a diagram illustrating an example of a configuration of an MBSFN subframe;

FIG. 2 is a diagram illustrating an example of a system configuration of a radio communication system according to an embodiment;

FIG. 3 is a diagram illustrating an example of the configuration of a radio frame according to the embodiment;

FIG. 4 is a diagram illustrating an example of an operation of the radio communication system according to the embodiment;

FIG. 5 is a sequence diagram illustrating a processing procedure performed by the radio communication system according to the embodiment;

FIG. 6 is a diagram illustrating an SFN-ID signaling method (alternative 1);

FIG. 7 is a diagram illustrating an SFN-ID signaling method (alternative 2);

FIG. 8A is a diagram for describing a PDSCH multiplexing method;

FIG. 8B is a diagram for describing a PDSCH multiplexing method;

FIG. 8C is a diagram for describing a PDSCH multiplexing method;

FIG. 8D is a diagram for describing a PDSCH multiplexing method;

FIG. 9 is a diagram illustrating an example of a functional configuration of a base station according to the embodiment;

FIG. 10 is a diagram illustrating an example of a functional configuration of user equipment according to the embodiment;

FIG. 11 is a diagram illustrating an example of a hardware configuration of the base station according to the embodiment; and

FIG. 12 is a diagram illustrating an example of a hardware configuration of the user equipment according to the embodiment.

### EMBODIMENTS OF THE INVENTION

In MBMS, wide-range and large-scale information delivery is originally assumed as in mobile TV broadcast. Therefore, the above-described MBSFN is designed such that all the system bands are occupied with specific subframes (referred to as MBSFN subframes) allocated quasi-statically and signals are transmitted. That is, MBSFN is a transmission scheme in which massive radio resources are consumed.

Accordingly, in Rel-13, a transmission scheme referred to as single cell point to multipoint (SC-PTM) and using a single cell is supported as a new transmission scheme to MBMS (see Non-Patent Document 1). SC-PTM is a transmission scheme for implementing MBMS closed within a single cell and can provide, for example, a small-scale MBMS service such as advertisement delivery or traffic information delivery by dynamically allocating resources of physical downlink shared channels (PDSCHs).

SC-PTM can implement an MBMS service without consuming massive radio resources; however, a transmission scheme is not supported such that a plurality of base stations cooperates to transmit signals, such as that of MBSFN.

Currently, 3GPP has studied vehicle to X (V2X) which is a part of intelligent transport systems (ITS) and has studied various technologies to implement V2X. For example, a proposal has been studied in which information is simultaneously delivered to a plurality of units of user equipment (automobiles, etc.) using SC-PTM. However, since SC-PTM is a scheme of transmitting signals over a single cell, a problem arises in that a transmission performance may deteriorate at cell ends. Note that, in 3GPP, no technique has been defined that can solve this problem. Furthermore, the problem is not limited to V2X and the problem can occur generally in LTE.

Hereinafter, embodiments of the present invention are described with reference to the drawings. The embodiments to be described below are merely examples and embodiments to which the present invention is applied are not limited to the following embodiments. For example, a radio communication system according to the embodiments is assumed to be a system of a scheme conforming to LTE. However, the invention is not limited to LTE, but other schemes can also be applied. In the present specification and the claims, “LTE” is used as meanings including not only a communication scheme corresponding to release 8 or 9 of 3GPP but also 3GPP releases 10, 11, 12, and 13; or a 5th-generation communication scheme corresponding to on and subsequent to release 14.

Layer 1 is synonymous with a physical layer (PHY). In addition, Layer 2 includes a medium access control (MAC) sublayer, a radio link control (RLC) sublayer, and a packet data convergence protocol (PDCP) sublayer. Layer 3 includes a radio resource control (RRC) layer.

<MBSFN Subframe>

Here, the above-described MBSFN subframes are described specifically with reference to the drawings. In MBMS, subframes other than numbers “0, 4, 5, and 9”, i.e., subframes of numbers “1, 2, 3, 6, 7, and 8”, among subframes of numbers 0 to 9 exist in one radio frame can be configured as MBSFN subframes. A radio frame in which a MBSFN subframe is configured and a position (a number) of the subframe are signaled to user equipment UE using broadcast information (SIB: System Information Block). More specifically, they are signaled using “MBSFN-SubframeConfig” specified in TS 36.311.

In a MBSFN subframe, a cell specific reference signal (CRS) is mapped only to a PDCCH region. Furthermore, in the PDSCH region, a MBSFN Reference Signal (MBSFN RS) is mapped, instead of a CRS.

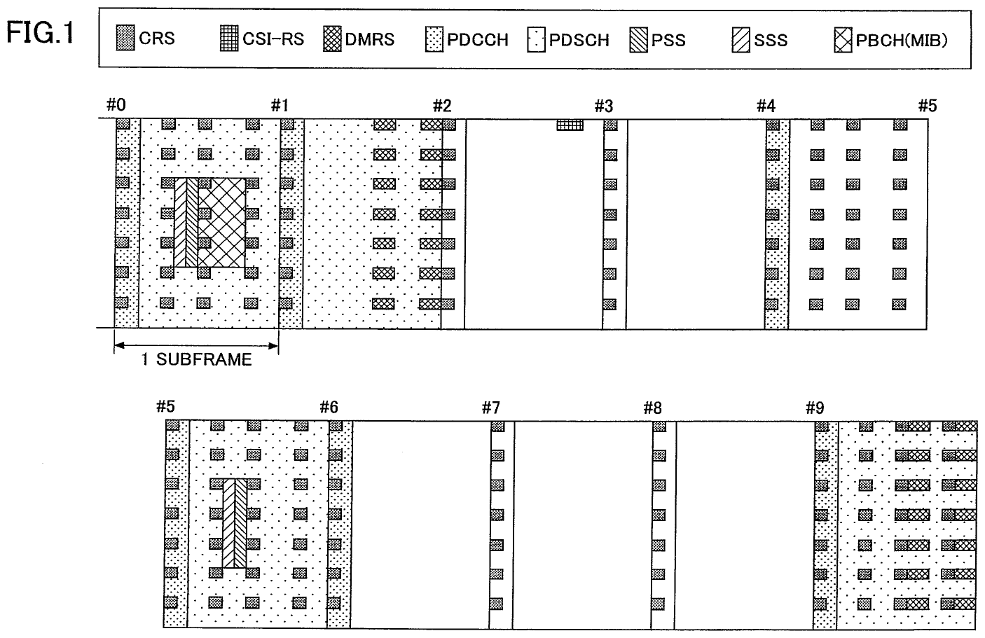

In the example of FIG. 1, a state is depicted in which subframes of numbers “2, 3, 6, 7, and 8” are configured in the MBSFN subframes.

<System Configuration>

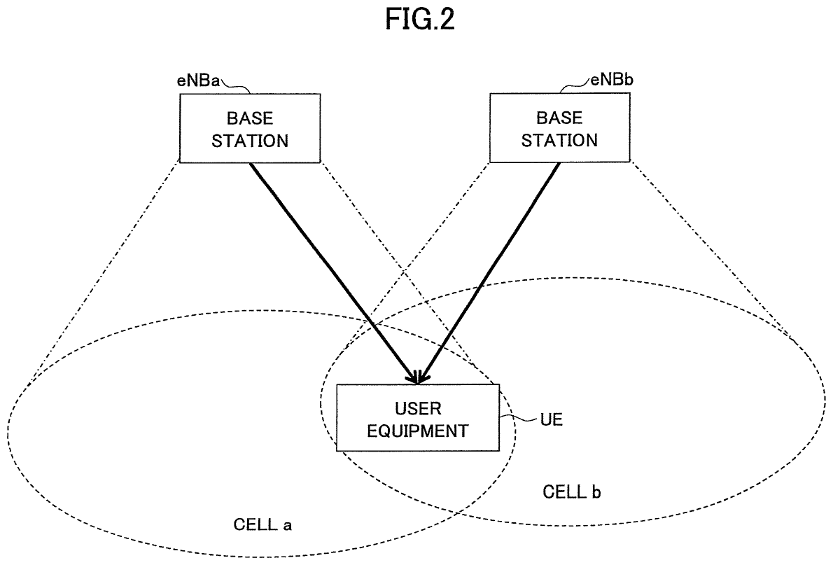

FIG. 2 is a diagram illustrating the configuration of a radio communication system according to the embodiment. The radio communication system according to the embodiment includes a base station eNBa, a base station eNBb, and user equipment UE. The base station eNBa forms a cell a and the base station eNBb forms a cell b. In the following, when the base stations eNBa and eNBb are not distinguished from each other, the base stations eNBa and eNBb are simply referred to as the “base stations eNB.” In FIG. 2, two base stations eNBs and one unit of user equipment UE are illustrated for the sake of convenience of illustration; however, there may be three or more base stations eNBs and two or more units of user equipment UE.

The user equipment UE may have a function of performing D2D communication in addition to a function of performing cellular communication. For example, each user equipment UE may be a vehicle, a terminal carried by a pedestrian, a rode side unit (RSU, which includes a UE-type RSU provided with a function of a UE), etc. Further, the user equipment UE may support V2X.

<Processing Procedure>

(Overview)

Next, a processing procedure performed by the radio communication system according to the embodiment is described. In the embodiment, the plurality of base stations eNB cooperates to perform signal transmission (implement signal frequency network (SFN)) while using the technology of SC-PTM. In the following, it is described assuming that two base stations eNBs (the base stations eNBa and eNBb) cooperate to operate. However, it is not limited to this, and the embodiment can also be applied to a case in which three or more base stations eNBs cooperate to operate.

In the embodiment, a new ID (hereinafter referred to as “SFN-ID” for convenience) is newly defined, which is used for generation of a reference signal mapped to a PDSCH region and scrambling of PDSCH. SFN-ID is commonly managed by the plurality of base stations eNBs that cooperates to operate. The base station eNB (either the base station eNBa or the base station eNBb) signals an SFN-ID to the user equipment UE, in advance, to which predetermined information is to be delivered, using a Layer 2 signal or a Layer 3 signal. When there are a plurality of units of user equipment UE to which predetermined information is to be delivered, the base station eNB signals the identical SFN-ID to the plurality of units of user equipment UE.

Next, the base stations eNBa and eNBb transmit, to the user equipment UE, PDSCH to which a reference signal generated using the same SFN-ID is mapped and which is scrambled using the same SFN-ID (hereinafter referred to “SFN-PDSCH” for convenience) when the predetermined information is delivered to one or more units of user equipment UE. The SFN-PDSCH can also be said to be PDSCH which can be received by a plurality of units of user equipment.

The user equipment UE obtains the predetermined information by decoding a signal of SFN-PDSCH received from the base station eNBa or/and the base station eNBb using the SFN-ID signaled in advance.

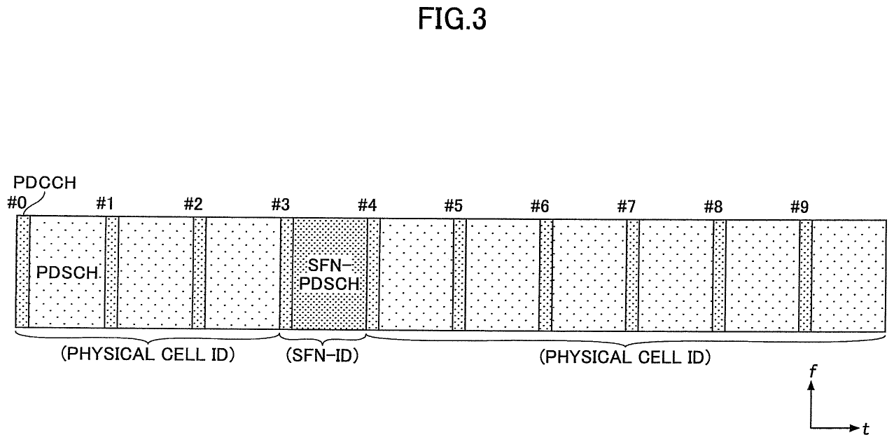

FIG. 3 is a diagram illustrating an example of the configuration of a radio frame according to the embodiment. The example of FIG. 3 indicates a case in which the embodiment is applied to subframe 3 among the subframes of numbers 0 to 9. In SFN-PDSCH, the base station eNB according to the embodiment operates to perform reference signal generation and scrambling using SFN-ID. Although not illustrated in FIG. 3, in the embodiment, SFN-PDSCH and EPDCCH can be frequency-multiplexed.

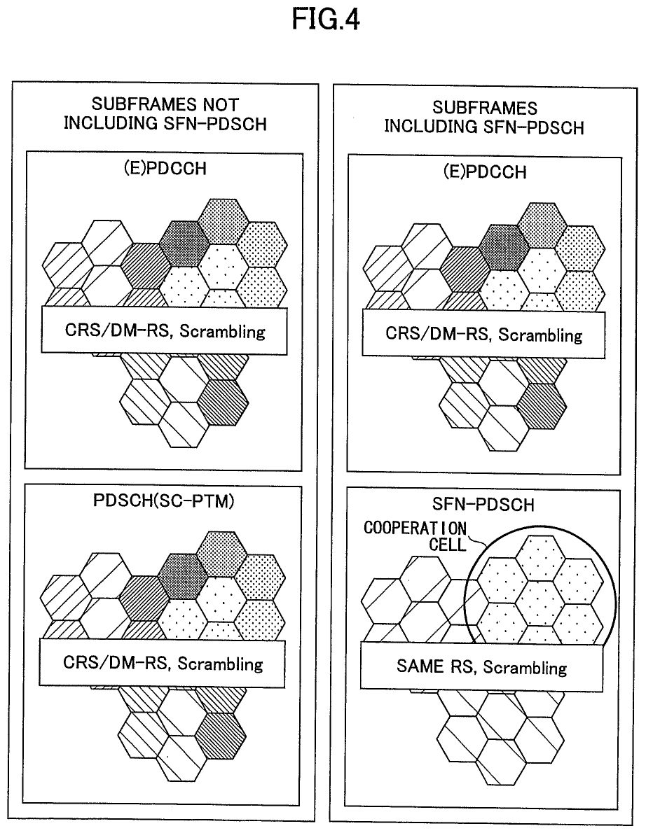

FIG. 4 is a diagram illustrating an example of an operation of the radio communication system according to the embodiment. As illustrated in FIG. 4, the base station eNB according to the embodiment performs the reference signal generation and the scrambling on (E) PDCCH in subframes including SFN-PDSCH using a physical cell ID (PCI: Physical Cell Identity), etc., which is a cell-specific ID as in LTE of the related art. However, the plurality of base stations eNBs cooperates to transmit the same signal (form a cooperation cell) by performing the reference signal generation and the scrambling on SFN-PDSCH using the same SFN-ID in a plurality of cells (cooperation cells). The radio communication system is operated so that the base stations eNBs to be cooperated are switched at a desired timing (the cooperation cells illustrated in FIG. 4 are moved), depending on necessity. As a result, as in SC-PTM, it is possible to resolve deterioration in a reception performance at cell ends by transmitting signals closed within a single cell. Note that, in a subframe not including the SFN-PDSCH, generation and a scrambling process of a reference signal are performed using a physical cell ID, etc., similar to LTE of the related art.

Here, in general, the user equipment UE performs channel estimation using CRS distributed and mapped in a PDSCH region when PDSCH is demodulated/decoded. More specifically, the user equipment UE performs channel estimation, not only using a CRS in a resource block scheduled for the user equipment UE itself, but also using a CRS in a resource block in the vicinity (in the frequency direction and in the time direction).

However, in the embodiment, an SFN-ID is used for the reference signal generation. That is, when the user equipment UE not supporting the embodiment does not aware of a reference signal generated in the processing procedure according to the embodiment and erroneously recognizes the reference signal as a CRS generated according to the LTE specification of the related art to perform channel estimation, it is possible that channel estimation is not correctly performed.

Accordingly, in the embodiment, in order to ensure backward compatibility with the user equipment UE not supporting the embodiment, the base station eNB may transmit SFN-PDSCH using a MSBSN subframe, instead of using any subframe. Even the user equipment UE not supporting the embodiment can recognize whether a subframe is an MBSFN subframe in accordance with broadcast information. In the LTE specification of the related art, it is defined that a CRS is not mapped to a region other than a region of PDCCH of the MBSFN subframes. Accordingly, by applying the embodiment only to MBSFN subframes, it is possible to ensure the backward compatibility. When the embodiment is implemented using dedicated carriers for providing a specific service, it is not necessary to consider the backward compatibility. Accordingly, a subframe configuration can be used such that SFN-ID is used in the whole subframe including a PDCCH region or SFN ID is used only in a part of the PDSCH region, instead of the MBSFN subframe. In this case, a subframe to which SFN-PDSCH can be applied is not limited to a specific subframe.

(Processing Sequence)

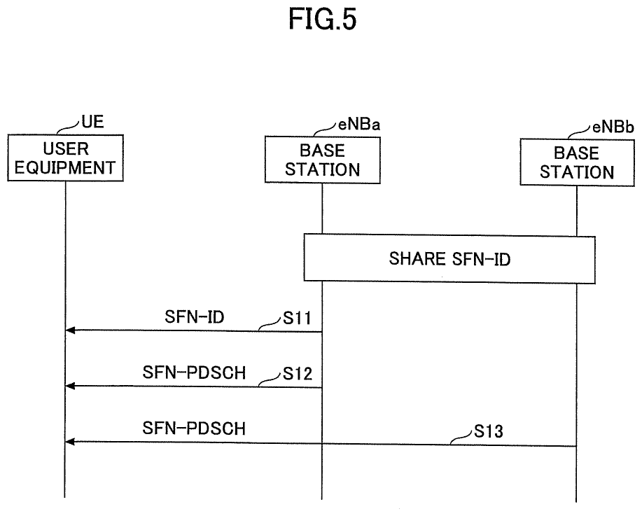

FIG. 5 is a sequence diagram illustrating a processing procedure performed by the radio communication system according to the embodiment. It is assumed that a radio resource (a subframe number, a resource block position, etc.) for transmitting SFN-ID and SFN-PDSCH are shared in advance between the base station eNBa and the base station eNBb.

The base station eNBa signals SFN-ID to the user equipment UE (S11). A specific signaling method is described below. Note that SFN-ID may be signaled from the base station eNBb instead of the base station eNBa. Subsequently, the base station eNBa transmits SFN-PDSCH with a predetermined subframe (S12). Similarly, the base station eNBb also transmits SFN-PDSCH with a subframe that is the same as that of the base station eNBa (S13). The user equipment UE decodes SFN-PDSCH simultaneously transmitted from the base stations eNBa and eNBb using SFN-ID signaled in the processing procedure of step S11 to obtain predetermined information (S12 and S13).

In the processing procedure of steps S12 and S13, the base station eNB may transmit downlink control information (DCI) corresponding to SFN-PDSCH using DCI format 1A or IC. Further, a CRC attached to the DCI may be scrambled with a Group-Radio Network Identify (G-RNTI) or a Single Cell-Radio Network Identify (SC-RNTI).

For transmission of the DCI, either PDCCH or EPDCCH may be used. The DCI may be transmitted in a common search space of PDCCH. By transmitting it in the common search space, if the user equipment UE can find, in advance, a subframe with which SFN-PDSCH is transmitted, the user equipment UE can receive SFN-PDSCH even if the user equipment UE is in an RRC IDLE state.

(Signaling of SFN-ID)

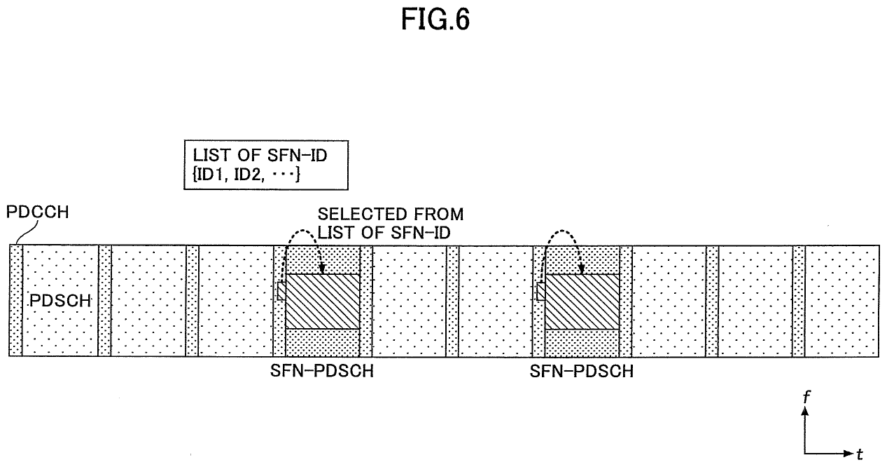

Next, the processing procedure of step S11 in FIG. 5 is described specifically with reference to the drawings. As illustrated in FIG. 6, the base station eNB may signal a list of SFN-ID to the user equipment UE using broadcast information, an RRC message, and so forth and may signal SFN-ID applied to SFN-PDSCH to the user equipment UE for each subframe by including SFN-ID in DCI. SFN-ID may be stored in a reserved region (reserved field) of DCI format 1A or 1C. It is not limited this and new DCI for specifying SFN-ID may be used. As a result, it is possible to dynamically change SFN-ID for each subframe.

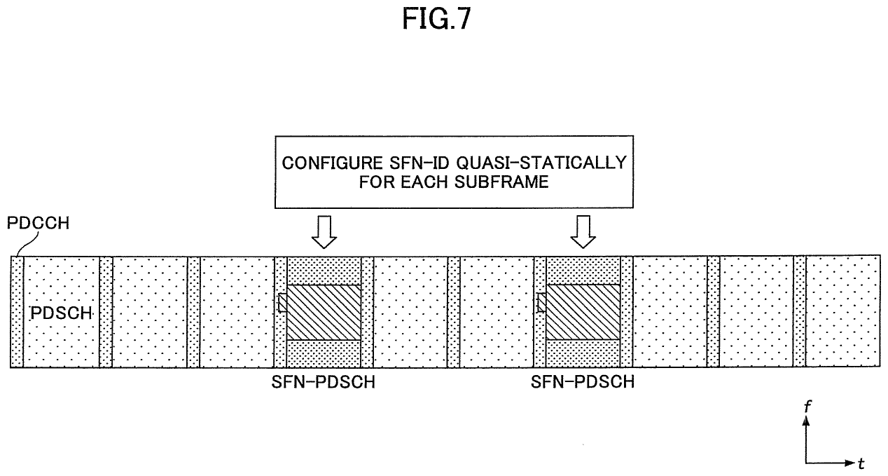

As illustrated in FIG. 7, the base station eNB may quasi-statically signal (configure) the SFN-ID applied to each subframe to the user equipment UE using the broadcast information, the RRC message, and so forth. In FIG. 7, SFN-ID may be a different value for each subframe or may be common to subframes.

(Multiplexing Method for PDSCH and SFN-PDSCH)

In the embodiment, SFN-PDSCH and PDSCH of the related art (that is, PDSCH which can be received by specific user equipment UE) may be frequency-multiplexed. Hereinafter, a plurality of variations of a specific multiplexing method is described. In the following description, PDSCH of the related art is described as “unicast PDSCH” to distinguish PDSCH of the related art from SFN-PDSCH.

[Alternative 1 of Multiplexing Method]

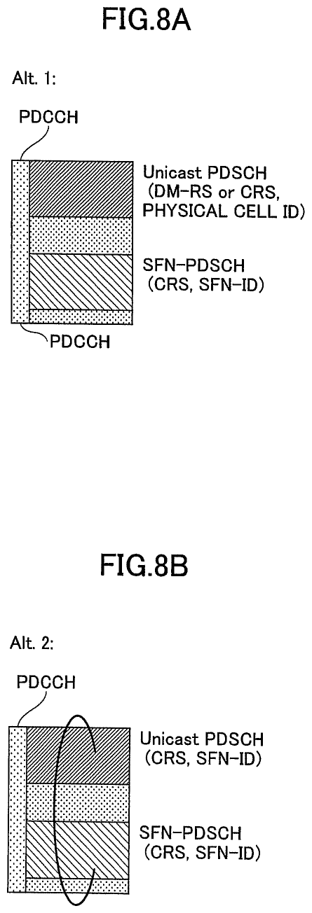

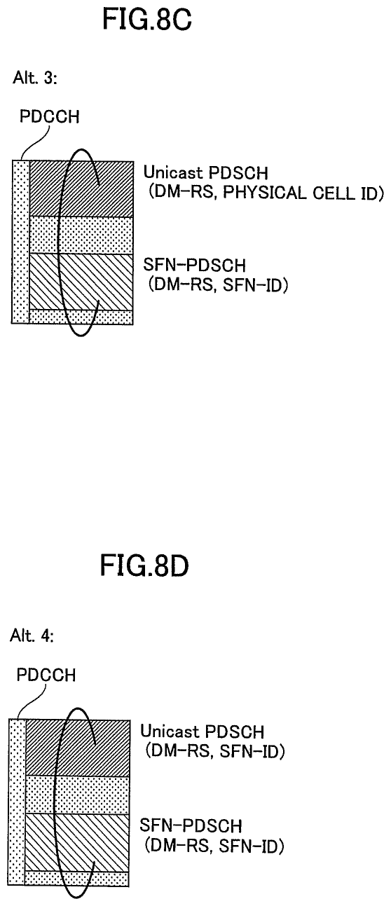

In alternative 1 of the multiplexing method, as illustrated in FIG. 8A, the base station eNB performs reference signal generation and scrambling on unicast PDSCH using a physical cell ID. For a reference signal, one of CRS and demodulation reference signal (DM-RS also referred to as a UE-specific reference signal) is used. The base station eNB performs reference signal generation and scrambling on SFN-PDSCH using SFN-ID. CRS is used for a reference signal.

In alternative 1 of the multiplexing method, the user equipment UE operates to recognize that there is at least CRS generated using SFN-ID in an SFN-PDSCH region to perform channel estimation. More specifically, the user equipment UE supporting the embodiment performs channel estimation using only CRS mapped to the SFN-PDSCH region at the time of receiving SFN-PDSCH and performs channel estimation using CRS or DM-RS mapped to a region other than the SFN-PDSCH region at the time of receiving unicast PDSCH.

In alternative 1 of the multiplexing method, unicast PDSCH is the same as PDSCH in LTE of the related art. That is, alternative 1 of the multiplexing method has the advantage that user equipment UE not supporting the embodiment can receive unicast PDSCH.

The user equipment UE of the related art not supporting the embodiment may not originally distinguish an SFN-PDSCH region from a unicast PDSCH region. That is, depending on the user equipment UE, channel estimation is performed using both of CRS in the unicast PDSCH region and CRS in the SFN-PDSCH region when unicast PDSCH is received, and it is possible that channel estimation precision is deteriorated. Accordingly, in alternative 1 of the multiplexing method, as described above, only MBSFN subframes may be used to ensure the backward compatibility.

[Alternative 2 of Multiplexing Method]

In alternative 2 of the multiplexing method, as illustrated in FIG. 8B, the base station eNB performs reference signal generation and scrambling on both of unicast PDSCH and SFN-PDSCH using SFN-ID. CRS is used for a reference signal.

In alternative 2 of the multiplexing method, CRS in a unicast PDSCH region is the same as CRS in a SFN-PDSCH region. That is, the user equipment UE supporting the embodiment can recognize that there is CRS in an entire system band and can perform channel estimation using CRS of the entire system band. Accordingly, it is possible to achieve high channel estimation precision.

In contrast, the user equipment UE of the related art not supporting the embodiment performs channel estimation without finding that the CRS is originally generated using SFN-ID. Accordingly, the user equipment UE may be incapable of correctly performing the channel estimation and may be incapable of receiving unicast PDSCH.

Accordingly, alternative 2 of the multiplexing method may be used only for the MBSFN subframe to ensure the backward compatibility.

[Alternative 3 of Multiplexing Method]

In alternative 3 of the multiplexing method, as illustrated in FIG. 8C, the base station eNB performs reference signal generation and scrambling on unicast PDSCH using a physical cell ID. DM-RS is used for a reference signal. The base station eNB performs reference signal generation and scrambling on SFN-PDSCH using SFN-ID. DM-RS is used for a reference signal. In alternative 3 of the multiplexing method, CRS is not included in an SFN-PDSCH region. Therefore, the user equipment UE supporting the embodiment operates to recognize that there is no CRS in the SFN-PDSCH region.

In contrast, the user equipment UE of the related art not supporting the embodiment recognizes that CRS is originally included in addition to DM-RS in a unicast PDSCH region other than MBSFN subframes. Accordingly, the user equipment UE of the related art may be incapable of normally performing a rate matching process and may be incapable of correctly receiving unicast PDSCH.

Accordingly, alternative 3 of the multiplexing method may only be used for MBSFN subframes to ensure the backward compatibility.

[Alternative 4 of Multiplexing Method]

In alternative 4 of the multiplexing method, as illustrated in FIG. 8D, the base station eNB performs reference signal generation and scrambling on both of unicast PDSCH and SFN-PDSCH using SFN-ID. DM-RS is used for a reference signal. In alternative 4 of the multiplexing method, CRS is not included in an SFN-PDSCH region. Therefore, the user equipment UE supporting the embodiment operates to recognize that there is no CRS in the SFN-PDSCH region.

In contrast, the user equipment UE of the related art not supporting the embodiment performs channel estimation without finding that the DM-RS is generated using the SFN-ID. Accordingly, the user equipment UE may be incapable of correctly performing the channel estimation and may be incapable of receiving unicast PDSCH. Thus, alternative 4 of the multiplexing method may be used only for MBSFN subframes to ensure the backward compatibility.

(Supplements of Processing Procedure)

The user equipment UE supporting the embodiment may monitor, in the common search space, DCI (format 1A or 1C) to which CRS masking (scrambling) is applied using G-RNTI or SC-RNTI in subframes including SC-PDSCH. Whether such an operation can be performed may be indicated from the base station eNB to the user equipment UE in a higher layer (RRC or the like). The user equipment UE may be able to monitor DCI masked with RA-RNTI in the MBSFN subframes.

The base station eNB may perform transmission in a PDSCH region of MBSFN subframes without using antenna port 7 or more (using antenna port 6 or less). The base station eNB may perform transmission in a PDSCH region of MBSFN subframes without using a transmission mode of mode 8 or more (using mode 7 or less).

In the processing procedure of steps S12 and S13 in FIG. 5, when EPDCCH is used to transmit DCI, a physical cell ID or a pre-decided cell ID may be used for generation of a reference signal (DM-RS) mapped to an EPDCCH region and scrambling of EPDCCH.

A type (CRS or DM-RS) of a reference signal mapped to a unicast PDSCH region or/and an SFN-PDSCH region and an ID (a physical cell ID or SFN-ID) to be used may be dynamically signaled to the user equipment UE using (E) PDCCH, or may be quasi-statically signaled (configured) to the user equipment UE using broadcast information or RRC signaling. In other words, the base station eNB may signal, to the user equipment UE, which multiplexing method is used among the above-described “alternatives 1 to 4 of the multiplexing method.” The user equipment UE may be dynamically signaled as to whether CRS is mapped to the entire system band (in other words, the above-described “alternative 2 of multiplexing method” is applied) in subframes in which SFN-PDSCH is configured using (E)PDCCH, or the user equipment UE may be quasi-statically signaled (configured) by broadcast information or RRC signaling. As a result, the base station eNB can appropriately switch a subframe configuration in consideration of the backward compatibility.

Furthermore, when a cell is operated which may be incapable of being used by user equipment UE according to related art not supporting the embodiment (or in which there is no user equipment according to related art not supporting the embodiment), all the cells may be regarded as MBSFN cells and the embodiment may be applied in the cell.

<Functional Configuration>

(Base Station)

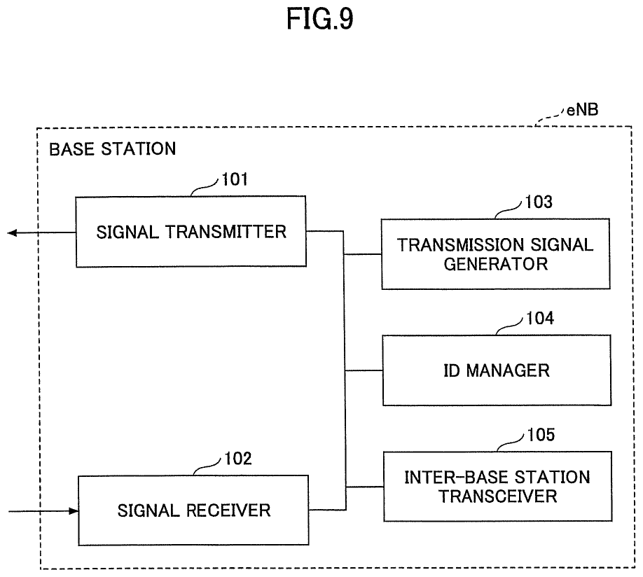

FIG. 9 is a diagram illustrating an example of a functional configuration of a base station according to the embodiment. As illustrated in FIG. 9, the base station eNB includes a signal transmitter 101, a signal receiver 102, a transmission signal generator 103, an ID manager 104, and an inter-base station transceiver 105. FIG. 9 illustrates only functional units particularly related to the embodiment of the present invention in the base station eNB and functions (not illustrated) of performing operations conforming to at least an LTE scheme are also included. The functional configuration illustrated in FIG. 9 is merely an example. Any functional division or names of the functional units may be used as long as operations according to the embodiment can be performed. Here, some (for example, only a specific one or a specific plurality of processing procedures) of the processes of the base station eNB described above may be executable.

The signal transmitter 101 has a function of generating a radio signal from a signal generated by the transmission signal generator 103 and transmitting the radio signal wirelessly. The signal receiver 102 has a function of receiving various signals wirelessly from the units of user equipment UE and retrieving signals of a higher layer from the received signals of a physical layer. Each of the signal transmitter 101 and the signal receiver 102 is assumed to include a packet buffer and perform processes of Layer 1 (PHY), Layer 2 (MAC, RLC, and PDCP), and Layer 3 (RRC) (however, not limited to these).

The signal transmitter 101 may perform frequency-multiplexing on unicast PDSCH and SFN-PDSCH generated by the transmission signal generator 103 and transmits the multiplexed unicast PDSCH and SFN-PDSCH to the user equipment UE with the predetermined subframe.

The transmission signal generator 103 has a function of generating PDSCH (including unicast PDSCH and SFN-PDSCH) based on the predetermined ID (the physical cell ID or SFN-ID). More specifically, the transmission signal generator 103 has a function of generating PDSCH to which the reference signal generated using the predetermined ID is mapped and which is scrambled using the predetermined ID when predetermined information is transmitted to the user equipment UE.

The transmission signal generator 103 may generate unicast PDSCH or SFN-PDSCH to which the reference signal (DM-RS or CRS) generated using SFN-ID is mapped. The transmission signal generator 103 may generate unicast PDSCH or SFN-PDSCH to which the reference signal (DM-RS or CRS) generated using the physical cell ID is mapped.

The ID manager 104 has a function of managing SFN-ID used between the plurality of base stations eNB that cooperate to operate. The ID manager 104 has a function to signal the SFN-ID to the user equipment UE using the broadcast information, RRC signaling, or DCI.

The inter-base station transceiver 105 has a function of sharing information regarding radio resources (subframe numbers, resource block positions, etc.) used to transmit SFN-ID and SFN-PDSCH between the plurality of base stations eNB that cooperate to operate.

(User Equipment)

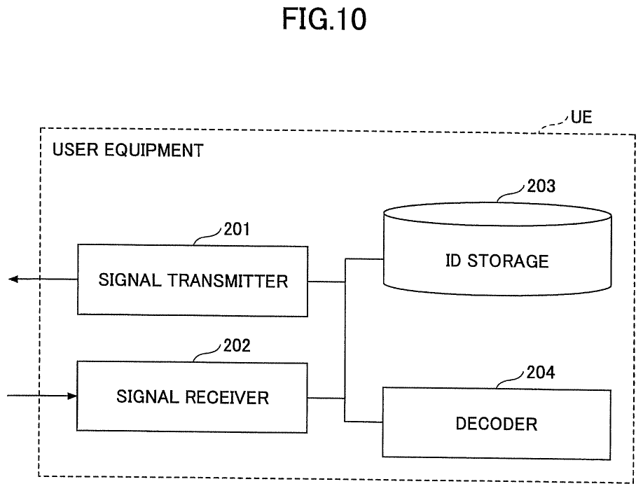

FIG. 10 is a diagram illustrating an example of a functional configuration of the user equipment according to the embodiment. As illustrated in FIG. 10, the user equipment UE includes a signal transmitter 201, a signal receiver 202, and ID storage 203, and a decoder 204. FIG. 10 illustrates only functional units particularly related to the embodiment of the invention in the user equipment UE and functions (not illustrated) of performing operations conforming to at least LTE are also included. The functional configuration illustrated in FIG. 10 is merely an example. Any functional division or names of the functional units may be used as long as operations according to the embodiment can be performed. Here, some (for example, only a specific one processing procedure or a specific plurality of processing procedures) of the processes of the user equipment UE described above may be executable.

The signal transmitter 201 has a function of generating various signals which are to be transmitted from the user equipment UE and transmitting the signals wirelessly. The signal receiver 202 has a function of receiving various radio signals from the base station eNB. Each of the signal transmitter 201 and the signal receiver 202 is assumed to include a packet buffer and perform processes of Layer 1 (PHY), Layer 2 (MAC, RLC, and PDCP), and Layer 3 (RRC) (but, it is not limited to these).

The signal receiver 202 has a function of receiving PDSCH (including unicast PDSCH and SFN-PDSCH) to which the reference signal generated using the predetermined ID (the physical cell ID or SFN-ID) is mapped with the predetermined subframe. The signal receiver 202 may receive SFN-PDSCH based on DCI obtained by monitoring the common search space.

The ID storage 203 has a function of storing the predetermined ID (the physical cell ID or SFN-ID) signaled from the base station eNB in a memory, etc.

The decoder 204 has a function of decoding PDSCH (including unicast PDSCH and SFN-PDSCH) received by the signal receiver 202 using the predetermined ID (the physical cell ID or SFN-ID). More specifically, the decoder 205 performs demodulation by correcting a channel variation of PDSCH using the reference signal (DM-RS or CRS) mapped to a PDSCH region using the predetermined ID and performs decoding by performing descrambling, decoding, and so forth on a demodulated signal.

The decoder 204 may decode the frequency-multiplexed SFN-PDSCH and unicast PDSCH using CRS mapped to the system band in the predetermined subframe.

All of the functional configurations of the base station eNB and the user equipment UE described above may be implemented by a hardware circuit (for example, one IC chip or a plurality of IC chips), or parts of the functional configurations may be formed of a hardware circuit and the remaining parts may be implemented by a CPU and a program.

(Base Station)

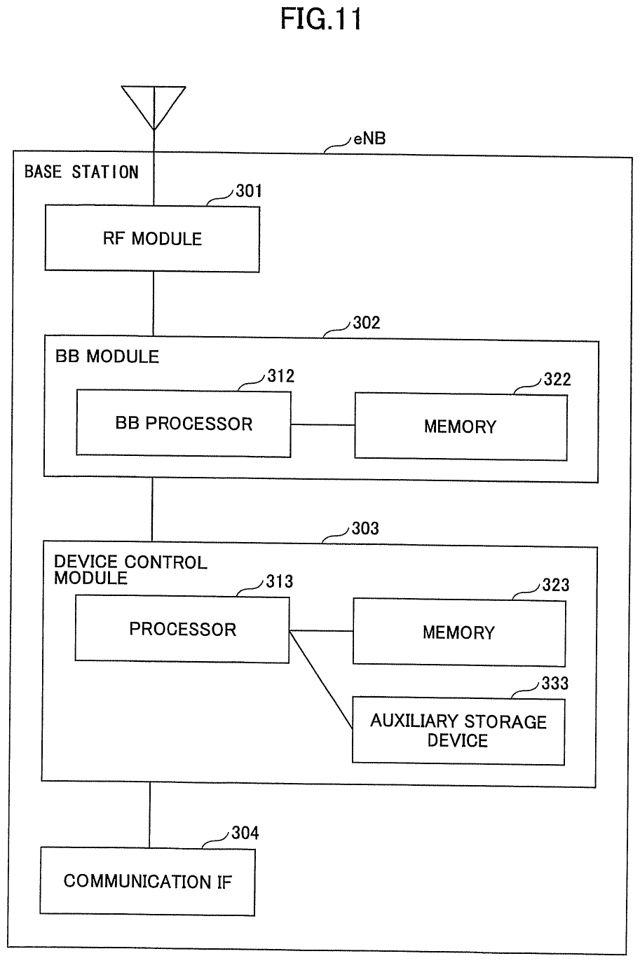

FIG. 11 is a diagram illustrating an example of a hardware configuration of the base station according to the embodiment. FIG. 11 illustrates a configuration closer to an implementation example than FIG. 9. As illustrated in FIG. 11, the base station eNB includes a radio frequency (RF) module 301 that performs a process on a radio signal, a baseband (BB) processing module 302 that performs baseband signal processing, a device control module 303 that performs a process of a high layer, etc., and a communication IF 304 that is an interface connected to a network.

The RF module 301 generates a radio signal to be transmitted from an antenna by performing digital-to-analog (D/A) conversion, modulation, frequency conversion, power amplification, and so forth on the digital baseband signal received from the BB processing module 302. The RF module 301 generates a digital baseband signal by performing frequency conversion, analog-to-digital (A/D) conversion, demodulation, and so forth on the received radio signal and delivers the digital baseband signal to the BB processing module 302. The RF module 301 includes, for example, parts of the signal transmitter 101 and the signal receiver 102 illustrated in FIG. 9.

The BB processing module 302 performs a process of mutually converting an IP packet and a digital baseband signal. A digital signal processor (DSP) 312 is a processor that performs signal processing in the BB processing module 302. A memory 322 is used as a work area of the DSP 312. The BB processing module 302 includes, for example, a part of the signal transmitter 101, a part of the signal receiver 102, and the transmission signal generator 103 illustrated in FIG. 9.

The device control module 303 performs an operation and maintenance (OAM) process and protocol processing of the IP layer. The processor 313 is a processor that performs a process which is performed by the device control module 303. The memory 323 is used as a work area of the processor 313. An auxiliary storage device 333 is, for example, an HDD and stores various types of configuration information used for the station eNB itself to operate. The device control module 303 includes, for example, the ID manager 104 illustrated in FIG. 9.

The communication IF 304 has a function of communicating with a core network and other base stations eNB. The communication IF 304 includes, for example, the inter-base station transceiver 105 illustrated in FIG. 9.

(User Equipment)

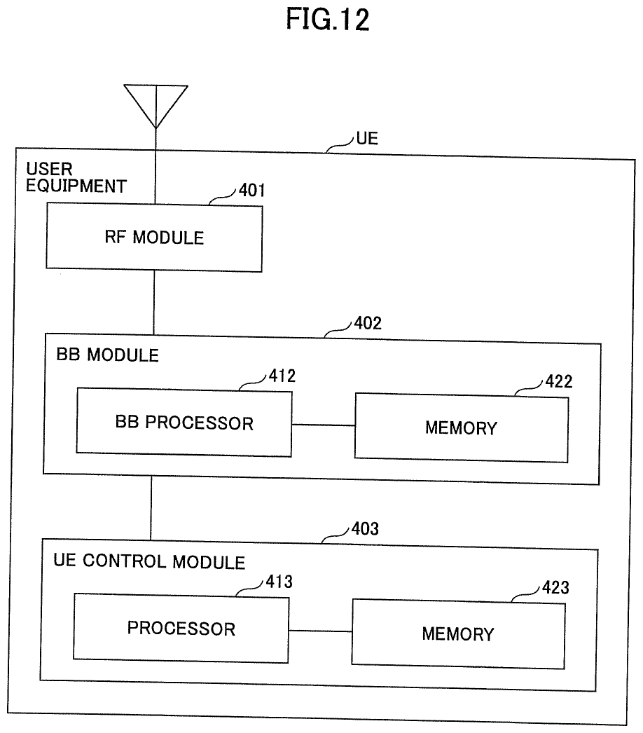

FIG. 12 is a diagram illustrating an example of a hardware configuration of the user equipment according to the embodiment. FIG. 12 illustrates a configuration closer to an implementation example than FIG. 10. As illustrated in FIG. 12, the user equipment UE includes an RF module 401 that performs process on a radio signal, a BB processing module 402 that performs baseband signal processing, and a UE control module 403 that performs a process of a high layer, etc.

The RF module 401 generates a radio signal to be transmitted from an antenna by performing D/A conversion, modulation, frequency conversion, power amplification, and so forth on the digital baseband signal received from the BB processing module 402. The RF module 401 generates a digital baseband signal by performing frequency conversion, A/D conversion, demodulation, and so forth on the received radio signal and delivers the digital baseband signal to the BB processing module 402. The RF module 401 includes, for example, parts of the signal transmitter 201 and the signal receiver 202 illustrated in FIG. 10.

The BB processing module 402 performs a process of mutually converting an IP packet and a digital baseband signal. A DSP 412 is a processor that performs signal processing in the BB processing module 402. A memory 422 is used as a work area of the DSP 412. The BB processing module 402 includes, for example, a part of the signal transmitter 201, a part of the signal receiver 202, and the decoder 204 illustrated in FIG. 10.

The UE control module 403 performs protocol processing of the IP layer and processes of various applications. A processor 413 is a processor that performs a process which is performed by the UE control module 403. A memory 423 is used as a work area of the processor 413. The UE control module 403 includes, for example, the ID storage 203 illustrated in FIG. 10.

<Conclusion>

As described above, according to the embodiment, there is provided a base station of a radio communication system including a plurality of base stations for communicating with user equipment, the base station including a generator that generates, based on a predetermined ID commonly configured for the plurality of base stations, a physical downlink shared channel capable of being received by a plurality of units of user equipment; and a transmitter that transmits the generated physical downlink shared channel to the user equipment in a predetermined subframe. By the base station eNB, there is provided a technique that allows, while efficiently utilizing radio resources, a plurality of base stations to cooperate to deliver information.

Here, the generator may further generate another downlink physical shared channel receivable by specific user equipment based on a cell ID for uniquely identifying a cell, and the transmitter may frequency multiplex the downlink physical shared channel receivable by the plurality of units of user equipment and the other downlink physical shared channel receivable by the specific user equipment and transmit the multiplexed downlink physical shared channels to the user equipment with a predetermined subframe. As a result, SFN-PDSCH and PDSCH of the related art can be frequency-multiplexed in the predetermined subframe, and radio resources can be efficiently used.

Further, the generator may further generate another downlink physical shared channel receivable by specific user equipment based on a predetermined ID used commonly in the plurality of base stations, and the transmitter may frequency multiplex the downlink physical shared channel receivable by the plurality of units of user equipment and the other downlink physical shared channel receivable by the specific user equipment and transmit the multiplexed downlink physical shared channels to the user equipment with a predetermined subframe. As a result, SFN-PDSCH and PDSCH of the related art can be frequency-multiplexed with the predetermined subframe and radio resources can be efficiently used.

Further, the downlink physical shared channel receivable by the plurality of units of user equipment may include a demodulation reference signal or a cell-specific reference signal generated using the predetermined ID. As a result, the user equipment UE receiving SFN-PDSCH can combine SFN-PDSCH transmitted from the plurality of base stations eNB and perform channel estimation.

Further, the predetermined subframe may be an MBSFN subframe. As a result, it is possible to ensure the backward compatibility with the user equipment UE of the related art not supporting the embodiment.

Further, according to the embodiment, there is provided user equipment of a radio communication system including a plurality of base stations communicating with the user equipment, the user equipment including a storage configured to store a predetermined ID used commonly in the plurality of base stations; a receiver configured to receive a downlink physical shared channel generated based on the predetermined ID and receivable by a plurality of units of user equipment with a predetermined subframe; and a decoder configured to decode the received downlink physical shared channel receivable by the plurality of units of user equipment using the predetermined ID. By this base station eNB, there is provided a technique that allows, while efficiently utilizing radio resources, a plurality of base stations to cooperate to deliver information.

Further, the receiver may further receive, with the predetermined subframe, another downlink physical shared channel receivable by the user equipment, wherein the other downlink physical shared channel receivable by the user equipment is frequency multiplexed with the downlink physical shared channel receivable by the plurality of units of user equipment and is generated using the predetermined ID, and the decoder may decode the downlink physical shared channel receivable by the plurality of units of user equipment and the other downlink physical shared channel receivable by the user equipment using a cell-specific reference signal mapped to a system band in the predetermined subframe. As a result, SFN-PDSCH and PDSCH of the related art can be frequency-multiplexed in the predetermined subframe, and radio resources can be efficiently used. The user equipment UE can perform channel estimation using CRS mapped to the entire system band, and thus it is possible to enhance channel estimation precision.

Further, the receiver may receive the downlink physical shared channel receivable by the plurality of units of user equipment based on control information included in a common search space in the predetermined subframe. As a result, the user equipment UE can receive SFN-PDSCH even in an RRC IDLE and can efficiently obtain desired information.

Further, according to the embodiment, there is provided a signal transmission method to be performed by a base station of a radio communication system including a plurality of base stations communicating with user equipment, the method including: generating a downlink physical shared channel receivable by a plurality of units of user equipment based on a predetermined ID commonly configured in the plurality of base stations; and transmitting the generated downlink physical shared channel to the user equipment with a predetermined subframe. According to the signal transmission method, there is provided a technique that allows, while efficiently utilizing radio resources, a plurality of base stations to cooperate to deliver information.

Furthermore, according to the embodiment, there is provided a signal reception method performed by user equipment of a radio communication system including a plurality of base stations communicating with the user equipment, the method including: storing a predetermined ID used commonly in the plurality of base stations in a storage; receiving a downlink physical shared channel generated based on the predetermined ID and receivable by a plurality of units of user equipment with a predetermined subframe; and decoding the received downlink physical shared channel receivable by the plurality of units of user equipment using the predetermined ID. According to the signal reception method, there is provided a technique that allows, while efficiently utilizing radio resources, a plurality of base stations to cooperate to deliver information.

<Supplements of Embodiments>

As described above, the configuration of each device (the user equipment UE/the base station eNB) described in the embodiment of the invention may be implemented by causing a CPU (processor) to execute a program in the device including the CPU and a memory or may be implemented by hardware such as a hardware circuit including a logic of the process described in the embodiment. Alternatively, the program and the hardware may be mixed.

Signaling of information is not limited to the aspects/embodiments described in this specification, and may be performed by another method. For example, signaling of information may be implemented by physical layer signaling (e.g., DCI (Downlink Control Information)), UCI (Uplink Control Information)), higher layer signaling (e.g., RRC signaling, MAC signaling, broadcast information (MIB (Master Information Block), SIB (System Information Block)), other signals or a combination thereof. Furthermore, the RRC message may be referred to as RRC signaling. Furthermore, the RRC message may be, for example, an RRC connection setup (RRC Connection Setup) message, an RRC connection reconfiguration (RRC Connection Reconfiguration) message, and so forth.

The aspects/embodiments described in the specification can be applied to LIE (Long Term Evolution); LTE-A (LTE-Advanced); SUPER 3G; IMT-Advanced; 4G; 5G; FRA (Future Radio Access); W-CDMA (registered trademark); GSM (registered trademark); CDMA 2000; UMB (Ultra Mobile Broadband); IEEE 802.11 (Wi-Fi); IEEE 802.16 (WiMAX); IEEE 802.20; UWE (Ultra Wide Band); Bluetooth (registered trademark); a system that utilizes another suitable system and/or a next generation system evolved based on these.

The decision or determination may be performed by a value (0 or 1) represented by one bit; may be performed by a Boolean value (Boolean: true or false); or by numerical value comparison (e.g., a comparison with a predetermined value).

Note that the terms described in this specification and/or terms required for understanding the specification may be replaced with terms having the same or similar meanings. For example, a channel and/or a symbol may be a signal (signal). Furthermore, a signal may be a message.

The UE may be referred to, by a person skilled in the art, as a subscriber station; a mobile unit; a subscriber unit; a wireless unit; a remote unit; a mobile device; a wireless device; a wireless communication device; a remote device; a mobile subscriber station; an access terminal; a mobile terminal; a wireless terminal; a remote terminal; a handset; a user agent; a mobile client; a client; or some other suitable terms.

The each aspect/embodiment described in the specification may be used alone; may be used in combination; or may be used by switching depending on execution. Furthermore, signaling of predetermined information (e.g., reporting of “being X”) is not limited to the method of explicitly performing, and may be performed implicitly (e.g., not perform signaling of the predetermined information).

The terms “determine (determining)” and “decide (determining)” may encompass a wide variety of operations. The “determine” and “decide” may include, for example, “determine” and “decide” what is calculated (calculating), computed (computing), processed (processing), derived (deriving), investigated (investigating), looked up (looking up) (e.g., looked up in tables, databases, or other data structures), ascertained (ascertaining). Furthermore, the “determine” and “decide” may include deeming that “determination” and “decision” are made on reception (receiving) (e.g., receiving information), transmission (transmitting) (e.g., transmitting information), input (input), output (output), and access (accessing) (e.g., accessing data in a memory). Furthermore, the “determine” and “decide” may include deeming that “determination” and “decision” are made on what is resolved (resolving), selected (selecting), chosen (choosing), established (establishing), and compared (comparing). Namely, the “determine” and “decide” may include deeming that some operation is “determined” or “decided.”

The term “based on” used in this specification does not imply “based only on” unless explicitly stated otherwise. In other words, the term “based on” implies both “based only on” and “based at least on.”

Furthermore, the order of the processing procedures, sequences, and so forth of the aspects/embodiments described in the specification may be re-arranged, provided that they do not contradict. For example, for the methods described in the specification, the elements of various steps are presented in an exemplary order, and are not limited to the specific order presented.

The input/output information, etc. may be stored in a specific location (e.g., a memory), or managed in a management table. The input/output information, etc. may be overwritten, updated, or additionally written. The output information, etc., may be deleted. The input information, etc., may be transmitted to another device.

Signaling of predetermined information (e.g., reporting of “being X”) is not limited to the method of explicitly performing, and may be implicitly performed (e.g., signaling of the predetermined information is not performed).

The information, signals, etc. described in the specification may be represented by using any of a variety of different techniques. For example, the data, indication, command, information, signal, bit, symbol, chip, etc., may be represented by a voltage, an electric current, an electromagnetic wave, a magnetic field or magnetic particles, a light field or photons, or any combination thereof.

The embodiments of the invention have been described above, but the disclosed invention is not limited to the embodiments. Those skilled in the art can understand various modifications, corrections, substitutions, replacements, and so forth. To promote understanding of the invention, the description has been made using examples of specific numerical values. These numerical values are merely examples and any appropriate values may be used unless otherwise stated. The classification of the sections in the foregoing description are not essential for the invention, but items described in two or more sections may be combined to be used as necessary or an item described in any section may be applied to another item described in another section (as long as they do not contradict). The boundaries of the functional units or the processing units in the functional block diagrams may not necessarily correspond to the boundaries of physical components. Operations of the plurality of functional units may be performed physically by one component or an operation of one functional unit may be performed physically by a plurality of components. In the sequence and the flowchart described in the embodiment, the order can be switched, provided that there is no contradiction. For convenience of the description of the processes, the user equipment UE and the base station eNB are described with reference to the functional block diagrams, but the devices may be implemented by hardware, software, or a combination thereof. Each of software operated by the processor included in the user equipment UE according to the embodiments of the present invention and software operated by the processor included in the base station eNB according to the embodiments of the present invention may be stored in any appropriate storage medium, such as a random access memory (RAM), a flash memory, a read-only memory (ROM), an EPROM, an EEPROM, a register, a hard disk (HDD), a removable disk, a CD-ROM, a database, and a server.

In the embodiments, SFN-ID is an example of the predetermined ID. SFN-PDSCH is an example of “a downlink physical shared channel receivable by a plurality of units of user equipment.” Unicast PDSCH (PDSCH of the related art) is an example of “a downlink physical shared channel receivable by specific user equipment.” DM-RS is an example of a demodulation reference signal. CRS is an example of a cell-specific reference signal.

This international patent application is based upon and claims the benefit of priority of Japanese Patent Application No. 2016-020325 filed on Feb. 4, 2016 and the entire content of Japanese Patent Application No. 2016-020325 is incorporated herein by reference

### LIST OF REFERENCE SYMBOLS

UE user equipment
eNB Base station
101 Signal transmitter
102 Signal receiver
103 Transmission signal generator
104 ID manager
105 Inter-base station transceiver
201 Signal transmitter
202 Signal receiver
203 ID storage
204 Decoder
301 RF module
302 BB processing module
303 Device control module
304 Communication IF
401 RF module
402 BB processing module
403 UE control module

1. A base station of a radio communication system including a plurality of base stations for communicating with user equipment, the base station comprising:
a generator that generates, based on a predetermined ID commonly configured for the plurality of base stations, a physical downlink shared channel capable of being received by a plurality of units of user equipment; and
a transmitter that transmits the generated physical downlink shared channel to the user equipment in a predetermined subframe.

2. The base station according to claim 1, wherein the generator further generates another downlink physical shared channel receivable by specific user equipment based on a cell ID for uniquely identifying a cell, and
wherein the transmitter frequency multiplexes the downlink physical shared channel receivable by the plurality of units of user equipment and the other downlink physical shared channel receivable by the specific user equipment and transmits the multiplexed downlink physical shared channels to the user equipment with a predetermined subframe.

3. The base station according to claim 1, wherein the generator further generates another downlink physical shared channel receivable by specific user equipment based on a predetermined ID used commonly in the plurality of base stations, and
wherein the transmitter frequency multiplexes the downlink physical shared channel receivable by the plurality of units of user equipment and the other downlink physical shared channel receivable by the specific user equipment and transmits the multiplexed downlink physical shared channels to the user equipment with a predetermined subframe.

4. The base station according to claim 2, wherein the downlink physical shared channel receivable by the plurality of units of user equipment includes a demodulation reference signal or a cell-specific reference signal generated using the predetermined ID.

5. The base station according to claim 1, wherein the predetermined subframe is an MBSFN subframe.

6. User equipment of a radio communication system including a plurality of base stations communicating with the user equipment, the user equipment comprising:
a storage configured to store a predetermined ID used commonly in the plurality of base stations;
a receiver configured to receive a downlink physical shared channel generated based on the predetermined ID and receivable by a plurality of units of user equipment with a predetermined subframe; and
a decoder configured to decode the received downlink physical shared channel receivable by the plurality of units of user equipment using the predetermined ID.

7. The user equipment according to claim 6, wherein the receiver further receives, with the predetermined subframe, another downlink physical shared channel receivable by the user equipment, wherein the other downlink physical shared channel receivable by the user equipment is frequency multiplexed with the downlink physical shared channel receivable by the plurality of units of user equipment and is generated using the predetermined ID, and
wherein the decoder decodes the downlink physical shared channel receivable by the plurality of units of user equipment and the other downlink physical shared channel receivable by the user equipment using a cell-specific reference signal mapped to a system band in the predetermined subframe.

8. The user equipment according to claim 6, wherein the receiver receives the downlink physical shared channel receivable by the plurality of units of user equipment based on control information included in a common search space in the predetermined subframe.

9. A signal transmission method to be performed by a base station of a radio communication system including a plurality of base stations communicating with user equipment, the method comprising:
generating a downlink physical shared channel receivable by a plurality of units of user equipment based on a predetermined ID commonly configured in the plurality of base stations; and
transmitting the generated downlink physical shared channel to the user equipment with a predetermined subframe.

10. A signal reception method performed by user equipment of a radio communication system including a plurality of base stations communicating with the user equipment, the method comprising:
storing a predetermined ID used commonly in the plurality of base stations in a storage;
receiving a downlink physical shared channel generated based on the predetermined ID and receivable by a plurality of units of user equipment with a predetermined subframe; and
decoding the received downlink physical shared channel receivable by the plurality of units of user equipment using the predetermined ID.
